(19) United States
(12) Patent Application Publication
(10) Pub. No.: US 2017/0172306 A1
(43) Pub. Date: Jun. 22, 2017

(54) THREEPARTS MODULAR FURNITURE SET

(71) Applicant: M&J SROUR PROPERTIES LLC, South Plainfield, NJ (US)

(72) Inventor: Mark SERURE, Brooklyn, NY (US)

(73) Assignee: M&J SROUR PROPERTIES LLC, South Plainfield, NJ (US)

(21) Appl. No.: 14/972,665

(22) Filed: Dec. 17, 2015

(51) Int. Cl. A47C 17/34; A47B 87/00; F16B 12/14; A47D 9/00; F16B 12/24; A47B 83/02; A47D 11/00

(52) U.S. Cl. CPC A47C 17/34; A47B 83/02; A47B 87/00; A47D 11/005; A47D 9/00; F16B 12/24; F16B 12/14

(57) ABSTRACT

A modular furniture set having three parts: two side parts configured as sitting furniture units; and at least one middle part,wherein all parts are configured such as to allow connecting each part to another part to build different furniture units and sets thereby, where the furniture units and sets comprise at least a bed with at least two different sizes and two sitting units which are formed by the two side parts.

### FIELD OF THE INVENTION

The present invention generally relates to the field of furniture and more particularly for modular furniture for forming a plurality of furniture units therefrom.

### BACKGROUND OF THE INVENTION

Baby, children and toddler beds are used for a limited period of time until the bed does not fit the size of the baby, toddler or child and therefore this bed furniture is usually either thrown, sold or given away after a few years.

To make use of baby furniture after the child outgrows it some manufacturers provide modular cots that enable turning the cot into a child's bed or a toy such as described in DE10011073.

### SUMMARY OF THE INVENTION

The present invention provides a modular furniture set having three parts: two side parts configured as sitting furniture units; and at least one middle part,wherein all parts are configured such as to allow connecting each part to another part to build different furniture units and sets thereby, where the furniture units and sets comprise at least a bed with at least two different sizes and two sitting units which are formed by the two side parts.

According to some embodiments, each of the parts comprises a base structure framed such as to connect to another part of the modular furniture set through connecting means. The side parts may also comprise back and/or side support structures.

Optionally, the connecting means comprise protruding pins configured for being inserted through recesses perforated over a frontal edge of the frames of the side and middle parts for interlocking said parts to one another.

Alternatively, the connecting means comprise screws and connecting plates.

According to some embodiments, the furniture set further comprises at least one mattress or pillow configured for fitting onto at least one of the furniture set parts.

According to some embodiments, the middle part comprises support legs for forming a table or stool when separated from the side parts.

Optionally, each of the side parts comprises support legs.

### BRIEF DESCRIPTION OF THE DRAWINGS

FIGS. 1A-1C show a modular furniture having three parts: two side parts and a middle part that can be modulated into several different furniture units or sets: a toddler's bed, a child's bed, a first sitting set comprising an elongated rest sofa and a shorter sofa, and a sitting set including a table or stool such as footstool and two sofas, according to some embodiments of the present invention: FIG. 1A shows the modular furniture assembled as a child's or a toddler's bed with all three parts connected to one another; FIG. 1B shows the first sitting set comprising an elongated rest sofa and a shorter sofa; and FIG. 1C shows the second sitting set including two sofas and a table.

FIGS. 2A-2B show another modular furniture having three parts: two side parts and a middle part that can be modulated into several different furniture units or sets: a toddler's bed, a child's bed, an elongated rest sofa and a sitting set including two sofas, according to some embodiments of the present invention: FIG. 2A shows the modular furniture disassembled (exploded view); FIG. 2B shows the set assembled as a toddler bed.

### DETAILED DESCRIPTION OF SOME EMBODIMENTS OF THE INVENTION

In the following detailed description of various embodiments, reference is made to the accompanying drawings that form a part thereof, and in which are shown by way of illustration specific embodiments in which the invention may be practiced. It is understood that other embodiments may be utilized and structural changes may be made without departing from the scope of the present invention.

The present invention provides a modular furniture set having at least three parts: at least one middle part and two side parts. The furniture is configured for building from its parts several beds and resting sets configurations including, for example, different sized toddler or child beds, and resting sets including sofas and optionally also a table.

The three or more parts can be used as a standalone furniture units such as table and sofas or assembled to form one or more other furniture units such as a toddler/child's bed or elongated resting sofa and the like.

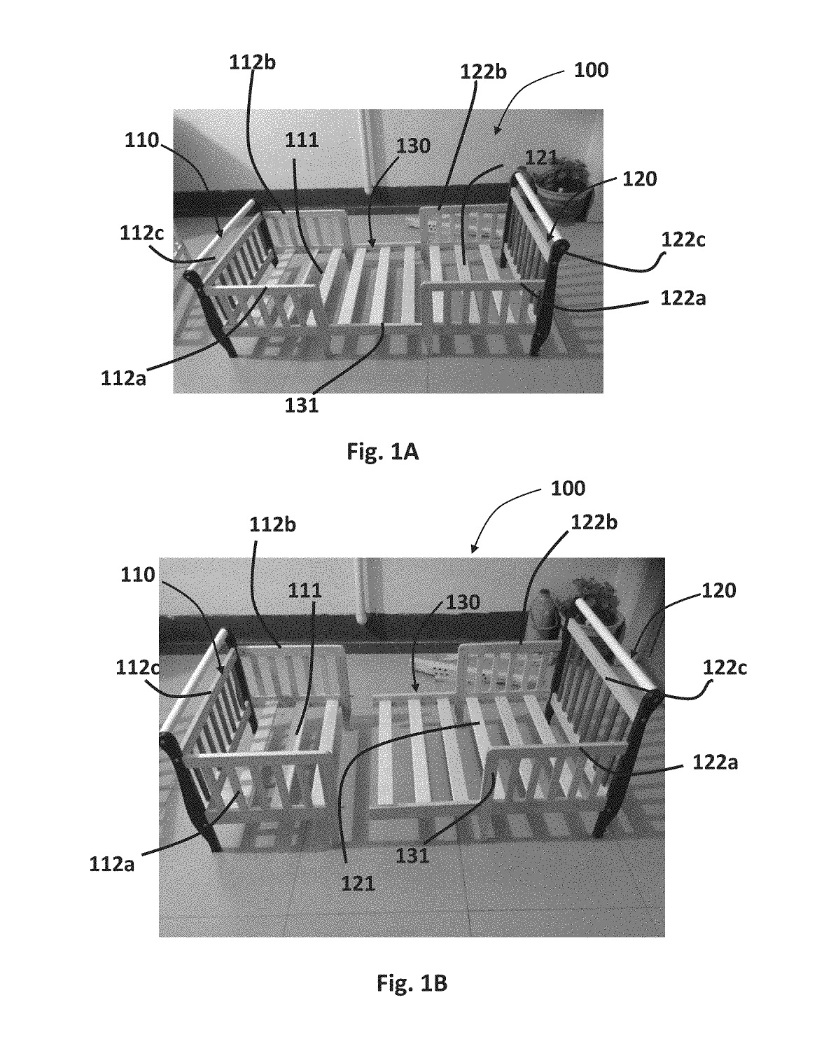

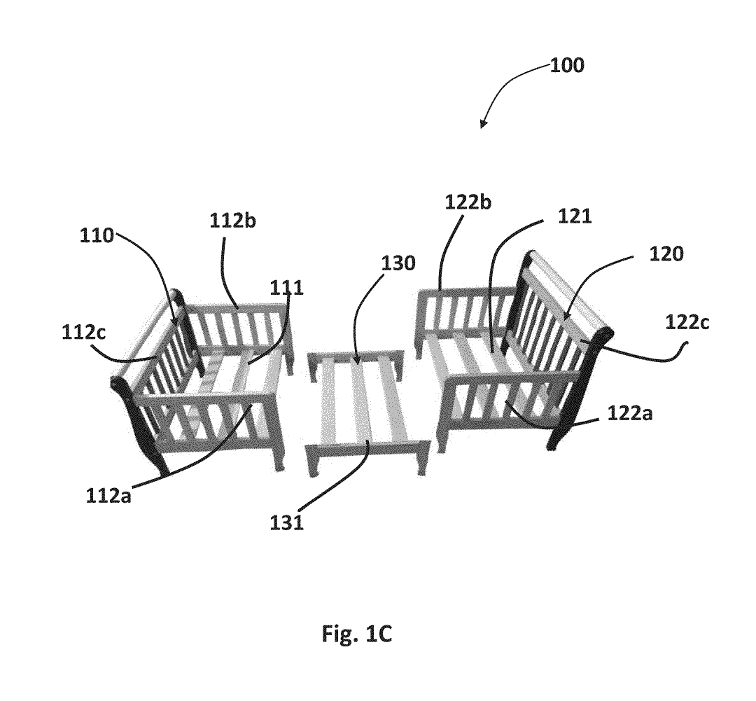

Reference is now made to FIGS. 1A-1C showing a modular furniture set 100 having three parts: two side parts 110 and 120 and a middle part 130 that can be modulated into several different furniture units or sets: a toddler's bed, a child's bed, a first sitting set comprising an elongated rest sofa and a shorter sofa, and a sitting set including a table and two sofas, according to some embodiments of the present invention.

FIG. 1A shows the modular furniture set 100 assembled as a child's or a toddler's bed with all three parts 110-130 connected to one another such that the two sides parts 110 and 120 connect to each side of the middle part 130 to form the bed design. Each part includes a base structure such as bases 111, 121 and 131 in this case constructed from multiple support boards. In other cases the bases may be constructed of a single platform board. Each of the side parts 110 and 120 includes one or more safety and/or support structures such as side supports 112a-112b and 122a-122b and back supports 112c and 122c.

Optionally, the middle part 130 also includes side supports for preventing falling of the child.

For younger or shorted children or toddlers the bed may be modulated such as not to include the middle part 130 by simply connecting the side parts 110 and 120 to one another (not shown).

FIG. 1B shows the first sitting set modulation of the modular furniture set 100 comprising an elongated rest sofa constructed by connecting one of the side parts 120 to the middle part 130; and a shorter sofa formed by the other side part 110 when disconnected.

FIG. 1C shows the second sitting set optional modulation of the modular furniture set 100 including two sofas formed by the disconnected two side parts 110 and 120 and a table, which is formed from the middle part 130.

Of course to use the furniture set 100 in any way for resting (whether sitting or laying) mattresses should be placed over the support bases of the sofas or bed fitting the furniture size in the respective modulated state thereof. For using the middle part 130 as a table placement of a table platform over the base 131 may be required unless the base 131 is formed from a platform board.

Any type and mechanism of removable connections can be used for connecting the parts 110-130 to one another such as by using interlocking niches and protrusions, bolts, screws and the like.

For example (not shown) the edges of the parts 110-130 that are supposed to connect or engage one another to form all the optional configurations and sets, may include recesses of the same size, depth etc., wherein to connect one part to another pin members can be inserted to the recesses of one of the parts to interlock into the recesses of the other part to which it should be connected.

In other embodiments connecting plates can be used with screws to connect the parts to one another.

In yet another embodiment, the parts can be simply placed adjacent to one another.

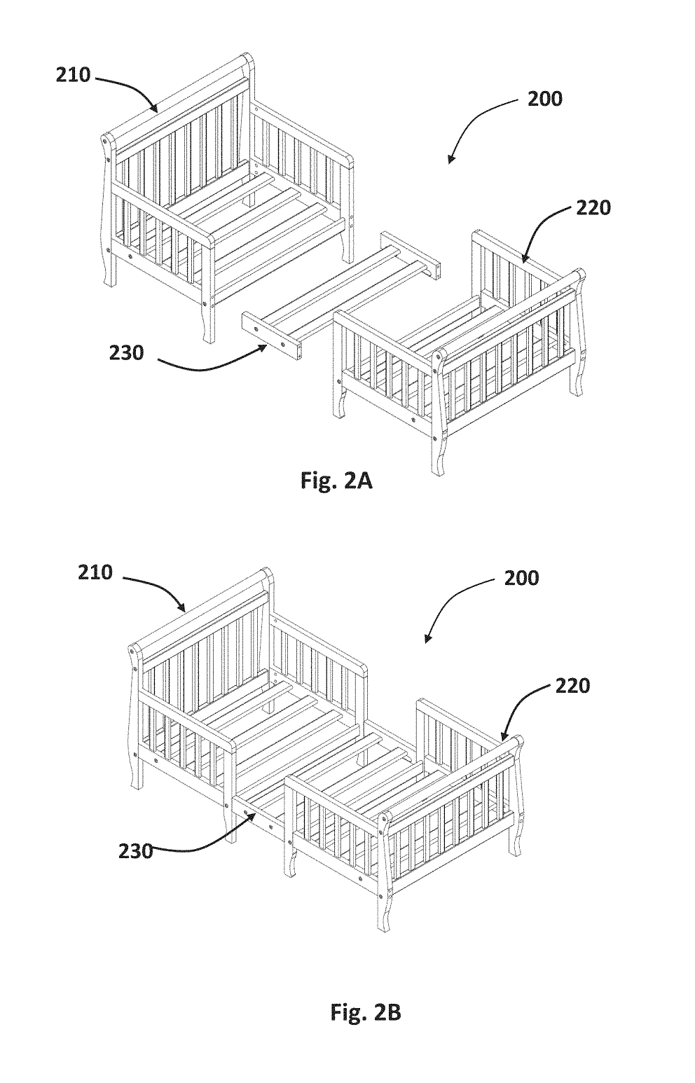

FIGS. 2A-2B show another modular furniture 200 having three parts: two side parts 210 and 220 and a middle part 230 that can be modulated into several different furniture units or sets: a toddler's bed such as shown in FIG. 2B, a child's bed (when the two side parts 210 and 220 are connected without the middle part 230), an elongated rest sofa (when one of the side parts 210/220 connects to the middle part 230) with another sofa which is the other side part 220/210 and a sitting set including two sofas which are the two side parts 210 and 220 when disconnected to one another and to the middle part 230, according to other embodiments of the present invention It is shown in FIG. 2A that the middle part 230 in this configuration does not have legs for supporting thereof and therefor to use it as a table legs or other support means must be attached thereto.

In some embodiments several middle parts are provided for extending the length of the bed to the desired size as the child grows and for using thereof as several tables or for modularly adjusting the size/length of the table by adding middle part units to one another and connecting support members such as legs at bottom edges thereof.

In some embodiments one or more mattresses and/or pillows are also provided as parts of the furniture set.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following invention and its various embodiments and/or by the following claims. For example, notwithstanding the fact that the elements of a claim are set forth below in a certain combination, it must be expressly understood that the invention includes other combinations of fewer, more or different elements, which are disclosed in above even when not initially claimed in such combinations. A teaching that two elements are combined in a claimed combination is further to be understood as also allowing for a claimed combination in which the two elements are not combined with each other, but may be used alone or combined in other combinations. The excision of any disclosed element of the invention is explicitly contemplated as within the scope of the invention.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a sub-combination or variation of a sub-combination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

Although the invention has been described in detail, nevertheless changes and modifications, which do not depart from the teachings of the present invention, will be evident to those skilled in the art. Such changes and modifications are deemed to come within the purview of the present invention and the appended claims.

1. A modular furniture set having three parts:
two side parts configured as sitting furniture units; and
at least one middle part,
wherein all parts are configured such as to allow connecting each part to another part to build different furniture units and sets thereby, said furniture units and sets comprise at least a bed with at least two different sizes and two sitting units which are formed by the two side parts.

2. The modular furniture set according to claim 1, wherein each of said parts comprises a base structure framed such as to connect to another part of the modular furniture set through connecting means.

3. The modular furniture set according to claim 2, wherein said side parts also comprise back and/or side support structures.

4. The modular furniture set according to claim 2, wherein said connecting means comprise protruding pins configured for being inserted through recesses perforated over a frontal edge of the frames of the side and middle parts for interlocking said parts to one another.

5. The modular furniture set according to claim 2, wherein said connecting means comprise screws and connecting plates.

6. The modular furniture set according to claim 1 further comprising at least one mattress or pillow configured for fitting onto at least one of the furniture set parts.

7. The modular furniture set according to claim 1, wherein said middle part comprises support legs for forming a table or stool when separated from said side parts.

8. The modular furniture set according to claim 1, wherein each of said side parts comprises support legs.
